(19) United States
(12) Patent Application Publication
(10) Pub. No.: US 2017/0168207 A1
(43) Pub. Date: Jun. 15, 2017

(54) BACKLIGHT MODULE FOR LIQUID CRYSTAL DISPLAY

(71) Applicant: Wuhan China Star Optoelectronics Technology Co., Ltd., Wuhan, Hubei (CN)

(72) Inventors: Zhongjie LIU, Wuhan, Hubei (CN); Yanxue ZHANG, Wuhan, Hubei (CN)

(73) Assignee: Wuhan China Star Optoelectronics Technology Co., L, Wuhan, Hubei (CN)

(21) Appl. No.: 14/779,165

(22) PCT Filed: Aug. 24, 2015
(86) PCT No.: PCT/CN2015/087915

§ 371 Date: Sep. 22, 2015

(30) Foreign Application Priority Data
Aug. 6, 2015 (CN) 201510475617.3

(51) Int. Cl. F21V 8/00

(52) U.S. Cl. CPC G02B 6/002; G02B 6/0055; G02B 6/0088

(57) ABSTRACT

A backlight module for liquid crystal display, having a back frame including a bottom plate and a side plate provided on a side end of the bottom plate, a light guide plate provided on the bottom plate, the light guide plate including a flat body and a wedge body extending upward from an end of the flat body. A light source is provided on the bottom plate and positioned between the wedge body and the side plate; and a flexible circuit board provided on the light source and the side plate and extending onto the wedge body. The backlight module can increase the brightness of the emitted light without increasing the thickness, so as to satisfy the needs of the high-resolution liquid crystal panel.

### TECHNICAL FIELD

The present disclosure relates to liquid crystal display field, and more particularly, to a backlight module used for liquid crystal display.

### BACKGROUND ART

In a backlight module of an existing liquid crystal display, point light source (such as light emitting diode and so on) is generally provided on one side end of light guide plate. In order to achieve better effect, a thickness of the flat type light guide plate must be equal to or larger than a diameter of the LED light source, and only in this way, can enable the light emitted from the LED light source to sufficiently enter the light guide plate.

The market trend is pursuing light and thin of portable products. Devices requiring liquid crystal displays, such as mobile phones, tablet PCs, notebook computers and the like, are becoming thinner and thinner. Therefore, there is a need to further reduce the thickness of the liquid crystal display. In the entire liquid crystal display, in addition to the liquid crystal panel, the backlight module will affect the thickness most. In order to reduce the thickness of the product, the most effective way is to reduce the thickness of the backlight module. However, with the increasing resolution of the liquid crystal panel in the portable product, the transmittance of the liquid crystal panel will reduce accordingly. Thus, a backlight module having higher brightness is needed to provide display light source to the liquid crystal panel.

In the prior art, the most effective way to increase the brightness of the backlight module is to use a high-power LED light source. However, such a method may have obvious defect, that is, the high-power LED light source may have a larger diameter, thus, after equipping the backlight module, in order to ensure that the thickness of the light guide plate is equal to or larger than the diameter of the LED light source, the thickness of the light guide plate must be increased. However, in the backlight module, the light guide plate may account for most of the thickness. As a result, the thickness of the entire backlight module will increase significantly as well.

### SUMMARY

In order to resolve the above problem existing in the prior art, the present disclosure provides a backlight module capable of increasing the brightness without increasing the thickness.

According to an aspect of the present disclosure, a backlight module for liquid crystal display is provided, including: a back frame including a bottom plate and a side plate provided on a side end of the bottom plate; a light guide plate provided on the bottom plate, the light guide plate including a flat body and a wedge body extending upward from an end of the flat body; a light source provided on the bottom plate and positioned between the wedge body and the side plate; and a flexible circuit board provided on the light source and the side plate and extending onto the wedge body.

Further, the backlight module further includes a black and white light-shielding adhesive provided between the flexible circuit board and the wedge body.

Further, the backlight module further includes a plurality of optical films provided on the flat body.

Further, the backlight module further includes a glue frame provided between the light source and the side plate.

Further, the backlight module further includes a reflector plate provided between the light guide plate and the bottom plate.

Further, a thicker end surface of the wedge body is an incident end surface (222a) adjacent to the light source, and a thinner end surface of the wedge body is joined smoothly with an end of the flat body.

Further, an end of the black and white light-shielding adhesive is propped to the light source.

Further, the sum of a thickness of the wedge body and a thickness of the black and white light-shielding adhesive is equal to a diameter of the light source.

Further, an end of each of the optical films is aligned with the other end of the black and white light-shielding adhesive.

Further, an end of the reflector plate extends to be propped to the side plate, wherein the light source and the glue frame are both provided on the reflector plate.

The advantageous effect of the present disclosure is as follows: the backlight module of the present disclosure may increase the brightness of the emitted light without increasing the thickness, so as to satisfy the needs of the high-resolution liquid crystal panel.

### BRIEF DESCRIPTION OF THE DRAWINGS

The above and/or other aspects, features and advantages of the embodiments in the disclosure will become apparent and more readily appreciated from the following description, taken in conjunction with the accompanying drawings in which:

FIG. 1 is a partial side view of a liquid crystal display according to an embodiment of the present disclosure.

### DETAILED DESCRIPTION OF EXEMPLARY EMBODIMENTS

Embodiments of the present disclosure will be described in detail below by referring to the accompany drawings. However, the present disclosure can be implemented in many different forms, and are not to be construed as being limited to the specific embodiments described herein. Rather, these embodiments are provided for explaining the principle and actual application of the present disclosure, thus other skilled in the art can understand various embodiments and amendments which are suitable for specific intended applications of the present disclosure. In the drawing, thicknesses of layers and regions are exaggerated so as to clarify the components, wherein the same reference numeral may be used to indicate the same component throughout the detailed description and drawings.

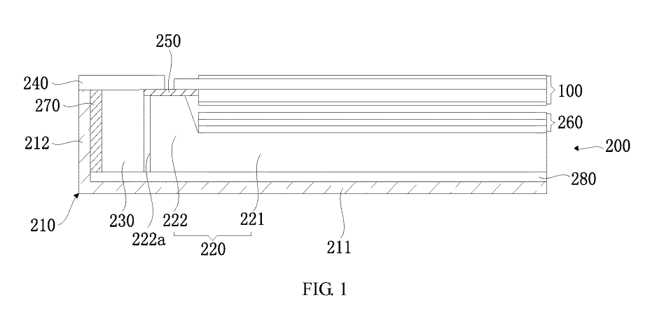

FIG. 1 is a partial side view of a liquid crystal display according to an embodiment of the present disclosure.

Referring to FIG. 1, a liquid crystal display according to the embodiment of the present disclosure includes a liquid crystal panel 100 and a backlight module 200 oppositely disposed, wherein the backlight module 200 provides display light source having high brightness to the liquid crystal panel 100 having high resolution, so as to allow the liquid crystal panel 100 to display images. In the present embodiment, the inventive point of the present disclosure aims at the backlight module 200, thus, in order to avoid repetition, the specific structure of the liquid crystal panel 100 will not be described in detail herein. Those skilled in the art may refer to a specific structure of the liquid crystal panel disclosed in the prior art.

Here, a detailed description will be provided on the backlight module 200 according to the embodiment of the present disclosure. Referring to FIG. 1, the backlight module 200 according to the embodiment of the present disclosure includes: a back frame (or back plate) 210, a light guide plate 220, a light source 230 and a flexible circuit board (FPC) 240.

FIG. 1 only shows a bottom plate 211 included in the back frame 210 and a side plate 212 provided on a side end of the bottom plate 211. It should be understood that, the back frame 210 generally includes the bottom plate 211 and the side plates 212 provided on four side ends of the bottom plate 211.

The light guide plate 220 is provided on the bottom plate 211 of the back frame 210. In the present embodiment, the light guide plate 220 includes a flat body 221 and a wedge body 222 extending along an end of the flat body 221. A thicker end surface of the wedge body 222 is an incident end surface 222a adjacent to the side plate 212 of back frame 210, and a thinner end surface of the wedge body 222 is joined smoothly with an end of the flat body 221.

The light source 230 may be, for example, a light emitting diode (LED), but the present disclosure is not limited thereto, for example, the light source 230 may also be, for example, a cold cathode fluorescent lamp (CCFL). The light source 230 is provided on the bottom plate 211 of the back frame 210, and the light source 230 is provided between the incident end surface 222a of the wedge body 222 and the side plate 212 of the back frame 210.

The flexible circuit board 240 is provided on the light source 230 and the side plate 212 of the back frame 210, and extends onto the wedge body 222 of the light guide plate 220. Generally, the flexible circuit board 240 is used to electrically connect the liquid crystal panel 100, and is used to provide power supply to the liquid crystal panel 100 and to drive control signals, and so on.

In order to prevent the light emitted from the light source 230 from being leaked between the light source 230 and the incident end surface 222a of the wedge body 222, the backlight module 200 according to the embodiment of the present disclosure further includes: a black and white light-shielding adhesive 250. The black and white light-shielding adhesive 250 is provided between the flexible circuit board 240 and the wedge body 222 of the light guide plate 220, and an end of the black and white light-shielding adhesive 250 is propped to the light source 230. In the present embodiment, preferably, the sum of the thickness of the incident end surface 222a of the wedge body 222 and the thickness of the black and white light-shielding adhesive 250 is equal to the diameter of the light source 230. However, the present disclosure is not limited thereto. For example, the sum of the thickness of the incident end surface 222a of the wedge body 222 and the thickness of the black and white light-shielding adhesive 250 may be slightly larger than the diameter of the light source 230.

The backlight module 200 according to the embodiment of the present disclosure further includes: a plurality of optical films 260. These optical films 260 may include the brightness enhancement film and the diffusion film and so on, which can improve the quality of the light provided by the flat body 221 of the light guide plate 220 to the liquid crystal panel 100. These optical films 260 may be sequentially provided on the flat body 221 of the light guide plate 220. Preferably, an end of each optical film 260 is aligned with the other end of the black and white light-shielding adhesive 250. However, the present disclosure is not limited thereto.

In order to fix the light guide plate 220, the light source 230 and so on in the back frame 210 in a better manner, the backlight module 200 according to the embodiment of the present disclosure further includes a glue frame 270. In FIG. 1, only a part of the glue frame 270 is shown, said part of the glue frame 270 is provided between the light source 230 and the side plate 212 of the back frame 210.

The backlight module 200 according to the embodiment of the present disclosure further includes: a reflector plate 280. The reflector plate 280 is provided between the light guide plate 220 and the bottom plate 211 of the back frame 210. Preferably, the reflector plate 280 extends to the side plate 212 of the back frame 210. That is to say, a part of the reflector plate 280 extending to the side plate 212 of the back frame 210 is provided between the light source 230 and the bottom plate 211 and between the glue frame 270 and the bottom plate 211. The reflector plate 280 may reflect the light reaching thereon back to the light guide plate 220, thereby increasing the light utilization ratio of the backlight module 200.

As mentioned above, the backlight module 200 and the liquid crystal panel 100 are provided opposite to each other. Specifically, the liquid crystal panel 100 is provided on the black and white light-shielding adhesive 250. The liquid crystal panel 100 displays images using the light improved by a number of optical films 260.

Based on above, according to the embodiment of the present disclosure, the brightness of the backlight module can be significantly increased without changing the thickness of the backlight module.

While the present disclosure has been shown and described with reference to the specific embodiments, it will be understood by those skilled in the art that various changes in form and details may be made therein without departing from the spirit and scope of the present disclosure as defined by the appended claims and its equivalents.

1. A backlight module for liquid crystal display, comprising:
a back frame including a bottom plate and a side plate provided on a side end of the bottom plate;
a light guide plate provided on the bottom plate, the light guide plate including a flat body and a wedge body extending upward from an end of the flat body;
a light source provided on the bottom plate and positioned between the wedge body and the side plate; and
a flexible circuit board provided on the light source and the side plate and extending onto the wedge body.

2. The backlight module of claim 1, further comprising a black and white light-shielding adhesive provided between the flexible circuit board and the wedge body.

3. The backlight module of claim 2, further comprising a plurality of optical films provided on the flat body.

4. The backlight module of claim 3, further comprising a glue frame provided between the light source and the side plate.

5. The backlight module of claim 4, further comprising a reflector plate provided between the light guide plate and the bottom plate.

6. The backlight module of claim 1, wherein a thicker end surface of the wedge body is an incident end surface adjacent to the light source, and a thinner end surface of the wedge body is joined smoothly with an end of the flat body.

7. The backlight module of claim 2, wherein an end of the black and white light-shielding adhesive is propped to the light source.

8. The backlight module of claim 2, wherein the sum of a thickness of the wedge body and a thickness of the black and white light-shielding adhesive is equal to a diameter of the light source.

9. The backlight module of claim 3, wherein an end of each of the optical films is aligned with the other end of the black and white light-shielding adhesive.

10. The backlight module of claim 5, wherein an end of the reflector plate extends to be propped to the side plate, wherein the light source and the glue frame are both provided on the reflector plate.
